(19) United States
(12) Patent Application Publication
(10) Pub. No.: US 2024/0420728 A1
(43) Pub. Date: Dec. 19, 2024

(54) DETECTING INTER-PERSON CONVERSATIONS USING A SMART WEARABLE DEVICE

(71) Applicant: Board of Regents, The University of Texas System, Austin, TX (US)

(72) Inventors: Edison Thomaz, Austin, TX (US); Dawei Liang, Austin, TX (US); Alice Zhang, Austin, TX (US)

(21) Appl. No.: 18/747,735

(22) Filed: Jun. 19, 2024

Related U.S. Application Data
(60) Provisional application No. 63/521,852, filed on Jun. 19, 2023.

(51) Int. Cl. G10L 25/78; G06N 3/0442; G10L 15/30

(52) U.S. Cl. CPC G10L 25/78; G06N 3/0442; G10L 15/30

(57) ABSTRACT

A method, smart wearable device and computer program product for detecting inter-person conversations. Audio data is captured on the smart wearable device. Such audio data may be from various sources, including sounds that only involve listening by an individual (e.g., television show) and sounds that involves an individual participating in face-to-face communication. Acoustic features are then extracted from the captured audio data. Such extracted acoustic features are a description of the captured audio data. Neural network embedding features are then extracted from the extracted acoustic features using a first neural network model. The extracted neural network embedding features are then fused into a second neural network model (configured to detect inter-person conversations based on detecting speaker change point(s)) to perform user conversation inference. In this manner, inter-person conversations are more effectively detected using a smart wearable device.

### TECHNICAL FIELD

The present disclosure relates generally to interpersonal communication, and more particularly to detecting inter-person conversations using a smart wearable device (e.g., smartwatch).

### BACKGROUND

Social interactions are communication exchanges between two or more individuals and play a critical role in society. They allow members of a community to socialize and provide a way for the spread and strengthening of cultural norms, values, and information. Because of its importance, the ability to passively and objectively track and quantify face-to-face social interactions is useful across several disciplines including behavioral sciences, information propagation and diffusion, social network analysis, and the study of health and well-being.

One of the fundamental components of social interactions is interpersonal communication (also referred to as “interpersonal conversations”), particularly face-to-face spoken communication (also referred to as “face-to-face conversations”). While face-to-face conversations have been traditionally studied and documented via self-reports, which poses a high-burden on individuals and introduces biases in the data, more recent methods have leveraged mobile devices to passively capture conversations in situ.

However, while many proposed approaches are capable of detecting the occurrence of speech, they generally fall short when it comes to inferring moments when users are talking versus listening (e.g., to other people, watching television) and detecting and characterizing conversations (e.g., infer if the speech was a monologue or part of a face-to-face conversation).

For example, attempts have been made to detect inter-person conversations, such as face-to-face conversation, without much success. For instance, one technique compares the mutual information or correlation between pairs of audio or voice streams captured from individual interacting subjects. To capture such signal streams, each subject holds an audio recording device, such as a smartphone, and signals collected by these devices are gathered to examine if a group of human subjects are within the same conversational session.

In another technique, which is a non-acoustic approach, respirational signals are detected by attaching a customized sensor board to a user's body.

Unfortunately, these approaches are deficient in detecting inter-person conversations. Furthermore, such approaches are difficult to implement requiring multiple devices or requiring a user to wear an uncomfortable device (e.g., customized sensor board).

### SUMMARY

In one embodiment of the present disclosure, a method for detecting inter-person conversations using a smart wearable device comprises capturing audio data on the smart wearable device. The method further comprises extracting acoustic features from the captured audio data. The method additionally comprises extracting neural network embedding features from the extracted acoustic features using a first neural network model. Furthermore, the method comprises fusing the extracted neural network embedding features into a second neural network model to perform user conversation inference.

Other forms of the embodiment of the method described above are in a smart wearable device and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the smart wearable device to detect inter-person conversations in accordance with an embodiment of the present disclosure;

FIG. 3 illustrates a customized neural network architecture that fuses feature representations extracted from model setups in accordance with an embedment of the present disclosure;

FIG. 4 illustrates an embodiment of the hardware configuration of the smart wearable device in accordance with an embodiment of the present disclosure; and

FIG. 5 is a flowchart of a method for detecting inter-person conversations using a smart wearable device in accordance with an embodiment of the present disclosure.

### DETAILED DESCRIPTION

As stated in the Background section, social interactions are communication exchanges between two or more individuals and play a critical role in society. They allow members of a community to socialize and provide a way for the spread and strengthening of cultural norms, values, and information. Because of its importance, the ability to passively and objectively track and quantify face-to-face social interactions is useful across several disciplines including behavioral sciences, information propagation and diffusion, social network analysis, and the study of health and well-being.

One of the fundamental components of social interactions is interpersonal communication (also referred to as “interpersonal conversations”), particularly face-to-face spoken communication (also referred to as “face-to-face conversations”). While face-to-face conversations have been traditionally studied and documented via self-reports, which poses a high-burden on individuals and introduces biases in the data, more recent methods have leveraged mobile devices to passively capture conversations in situ.

However, while many proposed approaches are capable of detecting the occurrence of speech, they generally fall short when it comes to inferring moments when users are talking versus listening (e.g., to other people, watching television) and detecting and characterizing conversations (e.g., infer if the speech was a monologue or part of a face-to-face conversation).

For example, attempts have been made to detect inter-person conversations, such as face-to-face conversation, without much success. For instance, one technique compares the mutual information or correlation between pairs of audio or voice streams captured from individual interacting subjects. To capture such signal streams, each subject holds an audio recording device, such as a smartphone, and signals collected by these devices are gathered to examine if a group of human subjects are within the same conversational session.

In another technique, which is a non-acoustic approach, respirational signals are detected by attaching a customized sensor board to a user's body.

Unfortunately, these approaches are deficient in detecting inter-person conversations. Furthermore, such approaches are difficult to implement requiring multiple devices or requiring a user to wear an uncomfortable device (e.g., customized sensor board).

The embodiments of the present disclosure provide a means for automated detection of inter-person conversations between an individual wearing a smart wearable device (e.g., smartwatch) and nearby individuals based on a neural network-based feature fusion framework. In one embodiment, the framework of the present disclosure includes a module for capturing audio data on the smart wearable device and extracting acoustic features from the captured audio data. Furthermore, the framework of the present disclosure includes a module for extracting neural network embedding features from the extracted acoustic features using a neural network model. Additionally, the framework of the present disclosure includes a module for fusing the extracted neural network embedding features into a second neural network model (configured to detect inter-person conversations based on detecting speaker change point(s)) to perform user conversation inference. These and other features will be discussed in further detail below.

In some embodiments of the present disclosure, the present disclosure comprises a method, smart wearable device and computer program product for detecting inter-person conversations. In one embodiment of the present disclosure, audio data is captured on the smart wearable device. Such audio data may be from various sources, including sounds that only involve listening by an individual (e.g., lecture from college professor, television show, monologue) and sounds that involves an individual participating in face-to-face communication. A “face-to-face” communication (also referred to herein as “inter-person conversations”), as used herein, refers to an exchange of information between two or more people. Acoustic features are then extracted from the captured audio data. Such extracted acoustic features are a description of the captured audio data. An example of acoustic features includes spectrogram features. Neural network embedding features are then extracted from the extracted acoustic features using a first neural network model. “Neural network embedding features,” as used herein, are learned low-dimensional representations of discrete data continuous vectors. Furthermore, the extracted neural network embedding features are fused into a second neural network model (configured to detect inter-person conversations based on detecting speaker change point(s)) to perform user conversation inference. In this manner, inter-person conversations are more effectively detected using a smart wearable device (e.g., smartwatch).

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

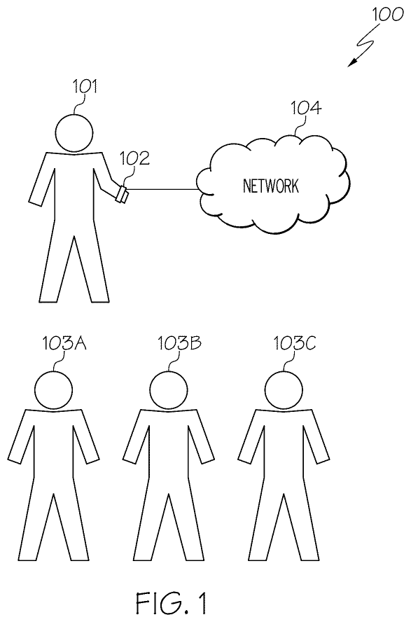

Referring now to the Figures in detail, FIG. 1 illustrates a communication system 100 for detecting inter-person conversations (e.g., face-to-face conversation) using a smart wearable device (e.g., smartwatch). As shown in FIG. 1, communication system 100 includes an individual 101 wearing a smart wearable device 102 (e.g., smartwatch) that is configured to detect the existence of inter-person conversations between individual 101 and one or more nearby individuals 103A-103C using only smart wearable device 102. Individuals 103A-103C may collectively or individually be referred to as individuals 103 or individual 103, respectively. In one embodiment, smart wearable device 102 is configured to infer inter-person conversations using acoustic sensing capabilities as discussed further below.

In one embodiment, smart wearable device 102 is connected to other computing devices via a network 104. In one embodiment, smart wearable device 102 offloads some or all of the computations discussed herein to such computing devices in order to detect inter-person conversations.

In one embodiment, smart wearable device 102 utilizes a framework with three modules, a foreground speech detector, a speaker change detector and a fusion engine. The foreground speech detector is configured to capture audio data on smart wearable device 102 and extract acoustic features from the captured audio data. The foreground speech detector then extracts neural network embedding features from the extracted acoustic features using a neural network model. The speaker change detector is configured to detect inter-person communications based on detecting speaker change points in the captured audio data using a second neural network model. In one embodiment, such speaker change points are detected within a range of 10-50 second intervals (e.g., 30 second intervals). The fusion engine uses a fusion model to fuse the extracted neural network embedding features into the second neural network model to perform user conversation inference. That is, the fusion model fuses the extracted neural network embedding features into the second neural network model to detect inter-person conversations. A further discussion regarding these and other features is provided further below.

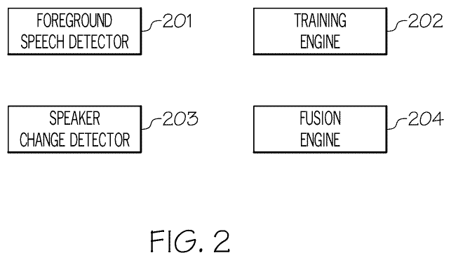

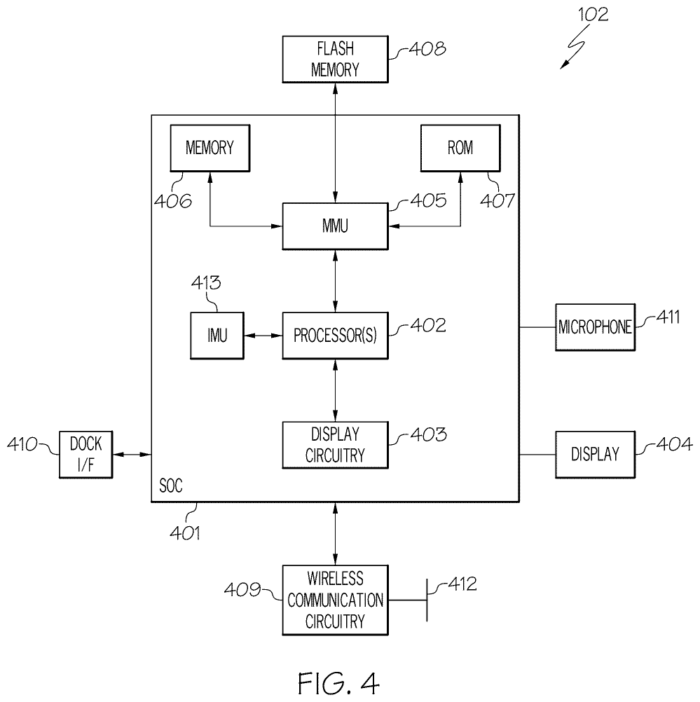

A description of the software components of smart wearable 102 used for detecting inter-person conversations is provided below in connection with FIG. 2. A description of the hardware configuration of smart wearable 102 is provided further below in connection with FIG. 4.

Network 104 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 is not to be limited in scope to any one particular network architecture. System 100 may include any number of individuals 101, 103, smart wearable devices 102 and networks 104.

Referring now to FIG. 2, in conjunction with FIG. 1, FIG. 2 is a diagram of the software components used by smart wearable device 102 (e.g., smartwatch) to detect inter-person conversations using smart wearable device 102 in accordance with an embodiment of the present disclosure.

In one embodiment, smart wearable device 102 includes a foreground speech detector 201 configured to capture audio data on smart wearable device 102 and extract acoustic features from the captured audio data. “Capturing,” as used herein, refers to recording or streaming audio data or temporarily possessing audio data that is not stored for further use. In one embodiment, such audio data is not stored for further use, but only temporarily retained, in order to preserve the privacy of the owner's audio data. Foreground speech detector 201 then extracts neural network embedding features from the extracted acoustic features using a neural network model.

In one embodiment, foreground speech detector 201 is further configured to capture inertial data, such as obtained from an inertial measurement unit (e.g., accelerometer, gyroscope) in smart wearable device 102, which is fused with audio data so as to consider not only verbal cues but also non-verbal gestures in conversations. That is, the captured audio data captures in-person verbal conversations; whereas, the captured inertial data captures non-verbal gestures. “Inertial data,” as used herein, refers to the acceleration and angular rate of smart wearable device 102.

In one embodiment, the captured non-verbal conversational gestures effectively supplement the information lost in downgraded audio.

In one embodiment, foreground speech detector 201 extracts both audio and inertial neural network embeddings from extracted acoustic and inertial features using separate neural network models. In one embodiment, such embeddings are combined through concatenation or cross-attention.

In one embodiment, foreground speech detector 201 takes as input a one-second audio instance each time and generates an inferred probability of foreground speech. In one embodiment, 30 second conversational instances are used. In one embodiment, the conversational instances may be from 10-50 seconds in duration. In one embodiment, the shape of the neural network layers of the neural network model are modified to fit the 30-second conversational instances. In one embodiment, foreground speech detector 201 utilizes a neural network model that consists of three two-dimensional (2D) convolutional layers using the rectified linear unit (ReLU) activation function. In one embodiment, the ReLU activation function introduces the property of nonlinearity to a deep learning model and solves the vanishing gradients issue. In one embodiment, the kernel size for each layer is (4×4), with a stride of (2×2). The outputs of the layers are padded to be of the same size as the inputs. In one embodiment, each convolutional layer comes with batch normalization and a max-pooling operation of a (2×2) kernel with the same stride. The fully-connected layers are activated by the ReLU activation except for the last one. In one embodiment, the neural network model has one to three neurons as output. In one embodiment, the fully-connected layers are also followed by batch normalization. To connect the convolutional layers and the fully-connected layers, the outputs of the last convolutional layer are flattened. In one embodiment, the neural network model is trained by a training engine 202 (discussed further below) of smart wearable device 102 using 0.5 million trainable parameters.

In one embodiment, foreground speech detector 201 utilizes a microphone and a voice capture application (e.g., Wear Audio Recorder, Easy Voice Recorder Pro, Voice Recorder by Smart Mobi® Tools, etc.) on smart wearable device 102 to capture audio, which may be audio from various sources, including sounds that only involve listening by individual 101 (e.g., lecture from college professor, television show, monologue) and sounds that involve individual 101 participating in face-to-face communication. A “face-to-face” communication (also referred to herein as “inter-person conversations”), as used herein, refers to an exchange of information between two or more people. As discussed herein, smart wearable device 102 utilizes the principles of the present disclosure to distinguish between inter-person conversations and other types of communications, such as listening, monologues, etc.

In one embodiment, foreground speech detector 201 stores the captured audio in a storage medium (e.g., memory) of smart wearable device 102.

In one embodiment, foreground speech detector 201 is configured to extract acoustic features from the captured audio data. Such extracted acoustic features are a description of the captured audio data that are fed into the neural network model discussed above. Examples of acoustic features include spectrogram features. A spectrogram is a visual representation of the spectrum of frequencies of a signal as it varies with time. When applied to an audio signal, spectrograms are used to identify spoken words phonetically. In one embodiment, a spectrogram is generated by an optical spectrometer, a bank of band-pass filters, by Fourier transform or by a wavelet transform. For example, the spectrogram is obtained by applying the short-time Fourier transform on the audio signal. In one embodiment, the short-time Fourier transform is calculated by applying the fast Fourier transform locally on small time segments of the signal.

Another example of an extracted acoustic feature is amplitude envelope, which provides an indication of the loudness of the audio signal which consists of the maximum amplitude values among all samples in each frame.

A further example of an extracted acoustic feature is the zero-crossing rate, which is the number of times a waveform crosses the horizontal time axis. Such a feature is used in recognizing voice/unvoiced decision for speech signals.

Another example of an extracted acoustic feature is the root mean square (RMS) energy, which acts as an indicator of loudness, since the higher the energy, the louder the sound.

Other examples of extracted acoustic features include spectral centroid, band energy ratio and spectral bandwidth. The spectral centroid provides the center of gravity of the magnitude spectrum. That is, it provides the frequency band where most of the energy is concentrated. The band energy ratio provides the relation between the lower and high frequency bands, which can be used to recognize similarities and differences between sounds. The spectral bandwidth (also referred to as the “spectral spread”) is derived from the spectral centroid. It is the spectral range of interest around the centroid. That is, the spectral bandwidth is the variance from the spectral centroid. The bandwidth is directly proportional to the energy spread across frequency bands, which is used to determine the quality of the sound.

In one embodiment, foreground speech detector 201 uses various software tools for extracting such acoustic features from the captured audio data, including, but not limited to, Librosa, TorchAudio, etc.

As discussed above, in one embodiment, foreground speech detector 201 extracts neural network embedding features from the extracted acoustic features using a neural network model. Neural network embedding features are learned low-dimensional representations of discrete data continuous vectors. In one embodiment, the neural network model is trained by training engine 202 of smart wearable device 102 to learn such embedding features. In one embodiment, such neural network embedding features are used to identify the types of speech, including foreground speech, ambiguous sounds, or other sounds. Foreground speech, as used herein, refers to regions in the captured audio where the person of interest (e.g., individual 101) is speaking. Hence, foreground speech includes situations where only individual 101 is talking or where there is an overlap between individual 101 and others (e.g., individuals 103) speaking. All other sound types, including speech from other individuals (e.g., individuals 103) and ambient noise may be categorized as “other sounds.” Instances of silence may also be classified as “other sounds” as well. Ambiguous sounds refer to sounds that may not be classified within a certain confidence level.

In one embodiment, training engine 202 uses a machine learning algorithm to build and train the neural network model (e.g., convolutional neural network) to extract appropriate neural network embedding features corresponding to foreground speech using a sample data set that includes learned low-dimensional representations of discrete data continuous vectors of foreground speech corresponding to various feature values for the acoustic features (e.g., spectrogram features, amplitude envelope, zero-crossing rate, root mean square (RMS) energy, spectral centroid, band energy ratio, spectral bandwidth, etc.). In one embodiment, such a sample data set is compiled by an expert.

Furthermore, such a sample data set is referred to herein as the “training data,” which is used by the machine learning algorithm to make predictions or decisions as to the appropriate neural network embedding features corresponding to foreground speech based on the training data. The algorithm iteratively makes predictions of appropriate neural network embedding features corresponding to foreground speech until the predictions achieve the desired accuracy as determined by an expert. In addition to neural networks discussed herein, examples of such learning algorithms include nearest neighbor, Naïve Bayes, decision trees, linear regression, and support vector machines.

Smart wearable device 102 further includes a speaker change detector 203 configured to detect inter-person conversations based on detecting speaker change points in the captured audio data corresponding to a boundary of speech turns for different speakers in a conversation using a second neural network model (an additional neural network model from the neural network model used by foreground speech detector 201). In one embodiment, such speaker change points are detected within 30 second intervals. In another embodiment, such speaker change points are detected within a range of 10-50 second intervals. A “speaker change point,” as used herein, is the boundary of speech turns for different speakers in a conversation.

In one embodiment, speaker change detector 203 utilizes a neural network model that consists of two bi-directional long short-term memory layers (LSTM) layers and three fully-connected layers. Different from the neural network model utilized by foreground speech detector 201, the extra LSTM layers enable speaker change detector 203 to better capture the speaker turn patterns in an audio sequence. The output sequence of the LSTM layers is directly passed to the first fully-connected layer without flattening. In one embodiment, the outputs of the first two fully-connected layers are activated by the Tanh activation function, and then globally averaged along the temporal dimension. In one embodiment, the output layer is modified as three neurons, activated by Softmax. In one embodiment, the number of trainable parameters is 0.7 million. In one embodiment, the inputs (e.g., spectrogram features every 30 seconds) to the neural network model utilized by speaker change detector 203 are the same as the inputs to the neural network model utilized by foreground speech detector 201.

In one embodiment, training engine 202 uses a machine learning algorithm to build and train the neural network model to detect inter-person conversations based on detecting speaker change points in the captured audio, such as within 30 second intervals, using a sample data set that includes features (e.g., spectrogram features) of speaker change points. In one embodiment, such a sample data set is compiled by an expert.

Furthermore, such a sample data set is referred to herein as the “training data,” which is used by the machine learning algorithm to make predictions or decisions as to detecting the inter-person conversations based on detecting speaker change points. The algorithm iteratively makes predictions of detecting inter-person conversations based on detecting speaker change points until the predictions achieve the desired accuracy as determined by an expert. In addition to neural networks discussed herein, examples of such learning algorithms include nearest neighbor, Naïve Bayes, decision trees, linear regression, and support vector machines.

Additionally, smart wearable device 102 includes a fusion engine 204 which uses a model (referred to herein as the “fusion model”) configured to fuse the extracted neural network embedding features (obtained from foreground speech detector 201) into the second neural network model to perform user conversation inference. That is, the fusion model is configured to fuse the extracted neural network embedding features (obtained from foreground speech detector 201) into the second neural network model to detect inter-person conversations.

In one embodiment, fusion engine 204 implements “intermediate fusion” (also referred to as “joint fusion”) where multiple models are trained (e.g., neural network models discussed above in connection with foreground speech detection and speaker change detection) and where the outputs of a first model become additional inputs to the second model. In intermediate data fusion, the interaction effects between variables are taken into account. Because of the step-wise fashion of the neural network models, the loss from the second model can be propagated back to the second model, updating weights for both models.

In one embodiment, fusion engine 204 implements “late fusion” which aggregates predictions at the decision level. In late fusion, the models are combined into a unified decision, which may be trained on disparate data. In one embodiment, the output of multiple models are aggregated using a multiple of techniques, such as majority voting, averaging, and weighted voting.

In one embodiment, fusion engine 204 utilizes the fusion model to augment the overall conversation modeling performance (feature fusion) by using the output of the neural network models discussed above. Canonically, feature fusion can be implemented at different stages of classification, from the input stage to the output decision stage. In one embodiment, the feature fusion is captured at the intermediate layers of the neural network models. In one embodiment, the feature fusion is captured at the final output layers of the neural network models.

In one embodiment, to enable fusion, training engine 202 builds and trains the fusion model with a similar model size compared to the individual baselines (neural network models of foreground speech detector 201 and speaker change detector 203). In one embodiment, the fusion model consists of two branches, each responsible for the foreground representations obtained by foreground speech detector 201 and the general-purpose acoustic spectrogram, respectively.

In one embodiment, the output representations of each branch are concatenated along the temporal dimension and fed to a stack of LSTM layers. In one embodiment, both branches of the fusion model fit with the same type of spectrogram features as the baselines, but the spectrogram is sliced to be 30 1-second clips for foreground knowledge extraction to improve the temporal precision of the representations. Hence, the input shapes per instance are (128×4) and (128×120), respectively, for the two branches of the fusion model.

In one embodiment, embedding features are extracted from the first fully-connected layer of the neural network model of foreground speech detector 201 instead of the last. In one embodiment, before concatenation, the extracted foreground representations are stacked every 30 seconds to match the output of the other branch. The 1D convolution is performed along the temporal dimension of the features in each branch. The number of trainable parameters is 0.8 million for the fusion model, which is lightweight for real-time deployment on edge devices.

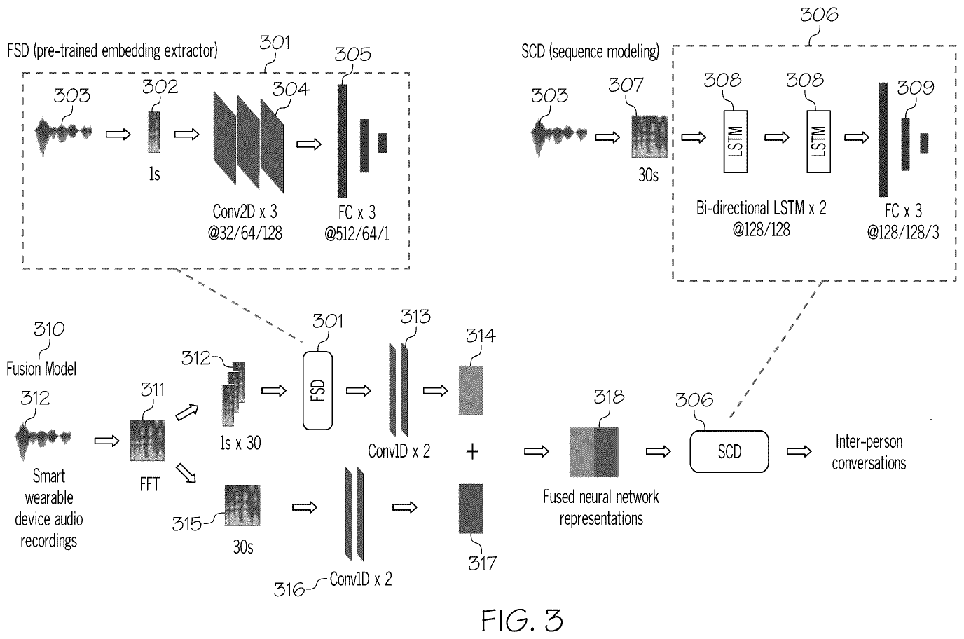

An illustrated framework of the present disclosure using the neural network models and fusion model discussed above is provided in FIG. 3.

In particular, FIG. 3 illustrates a customized neural network architecture that fuses feature representations extracted from model setups in accordance with an embedment of the present disclosure.

Referring to FIG. 3, in conjunction with FIGS. 1-2, the neural network model 301 of foreground speech detector 201 extracts neural network embedding features, which takes a one-second audio instance 302 of audio data 303 each time and generates an inferred probability of foreground speech. In one embodiment, such a neural network model consists of three 2D convolutional layers 304 and three fully connected layers 305.

Furthermore, as shown in FIG. 3, the neural network model 306 of speaker change detector 203 receives spectrogram features 307 extracted every 30 seconds from audio data 303 to capture the speaker turn patterns in an audio sequence. In one embodiment, such a neural network model 306 includes two bi-directional LSTM layers 308 and three fully connected layers 309.

Additionally, as illustrated in FIG. 3, a fusion model 310 performs a fast Fourier transform 311 on smart wearable device recordings 312, where thirty (30) one-second audio instances 312 are inputted into neural network model 301, the output of which is processed via two 2D convolutional layers 313 producing a neural network representation 314.

Furthermore, a single 30 second audio instance 315 is processed via two 1D convolutional layers 316 producing a neural network representation 317.

Additionally, as shown in FIG. 3, fusion model 310 combines or fuses neural network representations 314, 317 which forms a fused neural network representation 318 which is inputted into neural network model 306 of speaker change detector 203 to detect different types of communications, including inter-person conversations.

A description of an embodiment of the hardware configuration of smart wearable 102 for implementing such features is provided below in connection with FIG. 4.

FIG. 4 illustrates an embodiment of the hardware configuration of smart wearable 102 in accordance with an embodiment of the present disclosure.

As shown in FIG. 4, smart wearable device 102 includes a system on chip (SOC) 401. For example, as shown, SOC 401 may include processor(s) 402 which may execute program instructions for smart wearable device 102. Furthermore, SOC 401 includes display circuitry 403 which may perform graphics processing and provide display signals to display 404. Additionally, processor(s) 402 may also be connected to memory management unit (MMU) 405, which may be configured to receive addresses from the processor(s) 402 and translate those addresses to locations in memory (e.g., memory 406, read-only memory (ROM) 407, flash memory 408). In one embodiment, MMU 405 may be configured to perform memory protection and page table translation or setup. In some embodiments, MMU 405 may be included as a portion of processor(s) 402.

In one embodiment, smart wearable device 102 includes other circuits or devices, such as display circuitry 403, wireless communication circuitry 409, connector I/F 410 and/or display 404.

In the embodiment shown, ROM 407 may include a bootloader, which may be executed by processor(s) 402 during bootup or initialization. As also shown, SOC 401 may be connected to various other circuits of smart wearable device 102. For example, smart wearable device 102 may include various types of memory, a connector interface 410 (e.g., for connecting to a computer system), display 404, and wireless communication circuitry 409 (e.g., for communication using LTE, CDMA2000, Bluetooth, WiFi, NFC, GPS, etc.).

In one embodiment, smart wearable device 102 includes a microphone 411 configured to translate sound vibrations in the air into electronic signals and scribes them to a medium for temporary usage.

In one embodiment, smart wearable device 102 includes at least one antenna, and in some embodiments multiple antennas, for performing wireless communication with base stations and/or other devices. For example, smart wearable device 102 may use antenna 412 to perform the wireless communication. In one embodiment, smart wearable device 102 may in some embodiments be configured to communicate wirelessly using a plurality of wireless communication standards or radio access technologies (RATs).

In one embodiment, smart wearable device 102 further includes an inertial measurement unit (IMU) 413 connected to processor(s) 402. Examples of inertial measurement unit 413 include, but not limited to, an accelerometer, a gyroscope, etc. In one embodiment, IMU 413 is configured to obtain inertial data. As discussed above, “inertial data,” as used herein, refers to the acceleration and angular rate of smart wearable device 102.

As described herein, smart wearable device 102 may include hardware and software components for implementing methods according to embodiments of the present disclosure. In one embodiment, processor 402 is configured to implement part or all of the methods described herein, e.g., by executing program instructions stored on a memory medium (e.g., a non-transitory computer-readable memory medium). In other embodiments, processor 402 is configured as a programmable hardware element, such as a FPGA (Field Programmable Gate Array), or as an ASIC (Application Specific Integrated Circuit).

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an crasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, one of the fundamental components of social interactions is interpersonal communication (also referred to as “interpersonal conversations”), particularly face-to-face spoken communication (also referred to as “face-to-face conversations”). While face-to-face conversations have been traditionally studied and documented via self-reports, which poses a high-burden on individuals and introduces biases in the data, more recent methods have leveraged mobile devices to passively capture conversations in situ. However, while many proposed approaches are capable of detecting the occurrence of speech, they generally fall short when it comes to inferring moments when users are talking versus listening (e.g., to other people, watching television) and detecting and characterizing conversations (e.g., infer if the speech was a monologue or part of a face-to-face conversation). For example, attempts have been made to detect inter-person conversations, such as face-to-face conversation, without much success. For instance, one technique compares the mutual information or correlation between pairs of audio or voice streams captured from individual interacting subjects. To capture such signal streams, each subject holds an audio recording device, such as a smartphone, and signals collected by these devices are gathered to examine if a group of human subjects are within the same conversational session. In another technique, which is a non-acoustic approach, respirational signals are detected by attaching a customized sensor board to a user's body. Unfortunately, these approaches are deficient in detecting inter-person conversations. Furthermore, such approaches are difficult to implement requiring multiple devices or requiring a user to wear an uncomfortable device (e.g., customized sensor board).

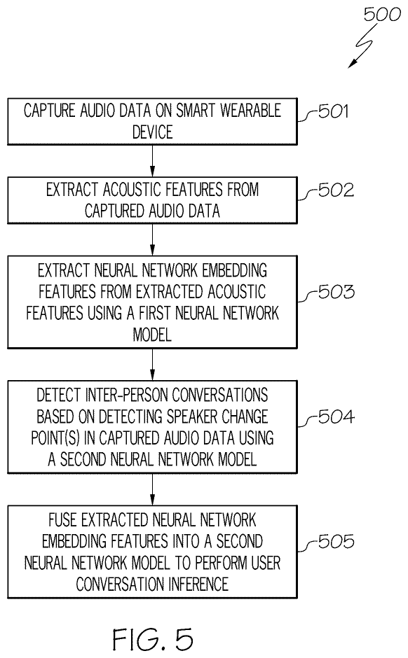

The embodiments of the present disclosure provide a means for automated detection of inter-person conversations between an individual wearing a smart wearable device (e.g., smartwatch) and nearby individuals based on a neural network-based feature fusion framework as discussed below in connection with FIG. 5.

FIG. 5 is a flowchart of a method 500 for detecting inter-person conversations using a smart wearable device (e.g., smart wearable device 102) in accordance with an embodiment of the present disclosure.

Referring to FIG. 5, in conjunction with FIGS. 1-4, in step 501, foreground speech detector 201 of smart wearable device 102 captures audio data on smart wearable device 102 using microphone 411.

As discussed above, in one embodiment, foreground speech detector 201 utilizes microphone 411 and a voice capture application (e.g., Wear Audio Recorder, Easy Voice Recorder Pro, Voice Recorder by Smart Mobi® Tools, etc.) on smart wearable device 102 to capture audio, which may be audio from various sources, including sounds that only involve listening by individual 101 (e.g., lecture from college professor, television show, monologue) and sounds that involve individual 101 participating in face-to-face communication. A “face-to-face” communication (also referred to herein as “inter-person conversations”), as used herein, refers to an exchange of information between two or more people. As discussed herein, smart wearable device 102 utilizes the principles of the present disclosure to distinguish between inter-person conversations and other types of communications, such as listening, monologues, etc.

In one embodiment, foreground speech detector 201 temporarily stores the captured audio in a storage medium (e.g., memory 406, 407) of smart wearable device 102.

In one embodiment, foreground speech detector 201 additionally captures inertial data, such as obtained from inertial measurement unit 413 (e.g., accelerometer, gyroscope) of smart wearable device 102, corresponding to non-verbal gestures in conversations. “Inertial data,” as used herein, refers to the acceleration and angular rate of smart wearable device 102.

In step 502, foreground speech detector 201 of smart wearable device 102 extracts acoustic features from the captured audio data.

As stated above, in one embodiment, foreground speech detector 201 is configured to extract acoustic features from the captured audio data. Such extracted acoustic features are a description of the captured audio data that are fed into the neural network model (discussed below). Examples of acoustic features include spectrogram features. A spectrogram is a visual representation of the spectrum of frequencies of a signal as it varies with time. When applied to an audio signal, spectrograms are used to identify spoken words phonetically. In one embodiment, a spectrogram is generated by an optical spectrometer, a bank of band-pass filters, by Fourier transform or by a wavelet transform. For example, the spectrogram is obtained by applying the short-time Fourier transform on the audio signal. In one embodiment, the short-time Fourier transform is calculated by applying the fast Fourier transform locally on small time segments of the signal.

Another example of an extracted acoustic feature is amplitude envelope, which provides an indication of the loudness of the audio signal which consists of the maximum amplitude values among all samples in each frame.

A further example of an extracted acoustic feature is the zero-crossing rate, which is the number of times a waveform crosses the horizontal time axis. Such a feature is used in recognizing voice/unvoiced decision for speech signals.

Another example of an extracted acoustic feature is the root mean square (RMS) energy, which acts as an indicator of loudness, since the higher the energy, the louder the sound.

Other examples of extracted acoustic features include spectral centroid, band energy ratio and spectral bandwidth. The spectral centroid provides the center of gravity of the magnitude spectrum. That is, it provides the frequency band where most of the energy is concentrated. The band energy ratio provides the relation between the lower and high frequency bands, which can be used to recognize similarities and differences between sounds. The spectral bandwidth (also referred to as the “spectral spread”) is derived from the spectral centroid. It is the spectral range of interest around the centroid. That is, the spectral bandwidth is the variance from the spectral centroid. The bandwidth is directly proportional to the energy spread across frequency bands, which is used to determine the quality of the sound.

In one embodiment, foreground speech detector 201 additionally extracts features from the captured inertial data.

In one embodiment, foreground speech detector 201 uses various software tools for extracting such acoustic and inertial features from the captured audio and inertial data, respectively, including, but not limited to, Librosa, TorchAudio, etc.

In step 503, foreground speech detector 201 of smart wearable device 102 extracts neural network embedding features from the extracted acoustic features using a first neural network model.

As discussed above, “neural network embedding features” are learned low-dimensional representations of discrete data continuous vectors. In one embodiment, the neural network model is trained by training engine 202 of smart wearable device 102 to learn such embedding features. In one embodiment, such neural network embedding features are used to identify the types of speech, including foreground speech, ambiguous sounds or other sounds. Foreground speech, as used herein, refers to regions in the captured audio where the person of interest (e.g., individual 101) is speaking. Hence, foreground speech includes situations where only individual 101 is talking or where there is an overlap between individual 101 and others (e.g., individuals 103) speaking. All other sound types, including speech from other individuals (e.g., individuals 103) and ambient noise may be categorized as “other sounds.” Instances of silence may also be classified as “other sounds” as well. Ambiguous sounds refer to sounds that may not be classified within a certain confidence level.

In one embodiment, training engine 202 uses a machine learning algorithm to build and train the neural network model (e.g., convolutional neural network) to extract appropriate neural network embedding features corresponding to foreground speech using a sample data set that includes learned low-dimensional representations of discrete data continuous vectors of foreground speech corresponding to various feature values for the acoustic features (e.g., spectrogram features, amplitude envelope, zero-crossing rate, root mean square (RMS) energy, spectral centroid, band energy ratio, spectral bandwidth, etc.). In one embodiment, such a sample data set is compiled by an expert.

Furthermore, such a sample data set is referred to herein as the “training data,” which is used by the machine learning algorithm to make predictions or decisions as to the appropriate neural network embedding features corresponding to foreground speech based on the training data. The algorithm iteratively makes predictions of appropriate neural network embedding features corresponding to foreground speech until the predictions achieve the desired accuracy as determined by an expert. In addition to neural networks discussed herein, examples of such learning algorithms include nearest neighbor, Naïve Bayes, decision trees, linear regression, and support vector machines.

Furthermore, as discussed above, in one embodiment, foreground speech detector 201 takes as input a one-second audio instance each time and generates an inferred probability of foreground speech. In one embodiment, 30 second conversational instances are used. In one embodiment, the conversational instances may be from 10-50 seconds in duration. In one embodiment, the shape of the neural network layers of the neural network model are modified to fit the 30-second conversational instances. In one embodiment, foreground speech detector 201 utilizes a neural network model that consists of three two-dimensional (2D) convolutional layers using the rectified linear unit (ReLU) activation function. In one embodiment, the ReLU activation function introduces the property of nonlinearity to a deep learning model and solves the vanishing gradients issue. In one embodiment, the kernel size for each layer is (4×4), with a stride of (2×2). The outputs of the layers are padded to be of the same size as the inputs. In one embodiment, each convolutional layer comes with batch normalization and a max-pooling operation of a (2×2) kernel with the same stride. The fully-connected layers are activated by the ReLU activation except for the last one. In one embodiment, the neural network model has one to three neurons as output. In one embodiment, the fully-connected layers are also followed by batch normalization. To connect the convolutional layers and the fully-connected layers, the outputs of the last convolutional layer are flattened. In one embodiment, the neural network model is trained by training engine 202 using 0.5 million trainable parameters.

In one embodiment, foreground speech detector 201 of smart wearable device 102 extracts neural network embedding features from the extracted inertial features using an additional neural network model. In one embodiment, such embeddings (embeddings from the extracted acoustic features and embeddings from the extracted inertial features) are combined through concatenation or cross-attention.

In step 504, speaker change detector 203 of smart wearable device 102 detects inter-person conversations based on detecting speaker change point(s) in the captured audio data using a second neural network model.

As stated above, a speaker change point corresponds to a boundary of speech turns for different speakers in a conversation. In one embodiment, such speaker change points are detected within 30 second intervals. In another embodiment, such speaker change points are detected within a range of 10-50 second intervals.

In one embodiment, speaker change detector 203 utilizes a neural network model (the second neural network model) that consists of two bi-directional long short-term memory layers (LSTM) layers and three fully-connected layers. Different from the neural network model utilized by foreground speech detector 201, the extra LSTM layers enable speaker change detector 203 to better capture the speaker turn patterns in an audio sequence. The output sequence of the LSTM layers is directly passed to the first fully-connected layer without flattening. In one embodiment, the outputs of the first two fully-connected layers are activated by the Tanh activation function, and then globally averaged along the temporal dimension. In one embodiment, the output layer is modified as three neurons, activated by Softmax. In one embodiment, the number of trainable parameters is 0.7 million. In one embodiment, the inputs (e.g., spectrogram features every 30 seconds) to the neural network model utilized by speaker change detector 203 are the same as the inputs to the neural network model utilized by foreground speech detector 201.

In one embodiment, training engine 202 uses a machine learning algorithm to build and train the neural network model (the second neural network model) to detect inter-person conversations based on speaker change points, such as within 30 second intervals, using a sample data set that includes features (e.g., spectrogram features) of speaker change points. In one embodiment, such a sample data set is compiled by an expert.

Furthermore, such a sample data set is referred to herein as the “training data,” which is used by the machine learning algorithm to make predictions or decisions as to detecting the inter-person conversations based on detecting speaker change points. The algorithm iteratively makes predictions of detecting inter-person conversations based on detecting speaker change points until the predictions achieve the desired accuracy as determined by an expert. In addition to neural networks discussed herein, examples of such learning algorithms include nearest neighbor, Naïve Bayes, decision trees, linear regression, and support vector machines.

In step 505, fusion engine 204 of smart wearable device 102 fuses the extracted neural network embedding features (obtained in step 503) into the second neural network model (discussed above) to perform user conversation inference using a model (referred to herein as the “fusion model”). That is, the fusion model is configured to fuse the extracted neural network embedding features (obtained in step 503) into the second neural network model (discussed above) to detect inter-person conversations.

As discussed above, in one embodiment, fusion engine 204 implements “intermediate fusion” (also referred to as “joint fusion”) where multiple models are trained (e.g., neural network models discussed above in connection with foreground speech detection and speaker change detection) and where the outputs of a first model become additional inputs to the second model. In intermediate data fusion, the interaction effects between variables are taken into account. Because of the step-wise fashion of the neural network models, the loss from the second model can be propagated back to the second model, updating weights for both models.

In one embodiment, fusion engine 204 implements “late fusion” which aggregates predictions at the decision level. In late fusion, the models are combined into a unified decision, which may be trained on disparate data. In one embodiment, the output of multiple models are aggregated using a multiple of techniques, such as majority voting, averaging, and weighted voting.

In one embodiment, fusion engine 204 utilizes the fusion model to augment the overall conversation modeling performance (feature fusion) by using the output of the neural network models discussed above. Canonically, feature fusion can be implemented at different stages of classification, from the input stage to the output decision stage. In one embodiment, the feature fusion is captured at the intermediate layers of the neural network models. In one embodiment, the feature fusion is captured at the final output layers of the neural network models.

In one embodiment, to enable fusion, training engine 202 builds and trains the fusion model with a similar model size compared to the individual baselines (neural network models of foreground speech detector 201 and speaker change detector 203). In one embodiment, the fusion model consists of two branches, each responsible for the foreground representations obtained by foreground speech detector 201 and the general-purpose acoustic spectrogram, respectively.

In one embodiment, the output representations of each branch are concatenated along the temporal dimension and fed to a stack of LSTM layers. In one embodiment, both branches of the fusion model fit with the same type of spectrogram features as the baselines, but the spectrogram is sliced to be 30 1-second clips for foreground knowledge extraction to improve the temporal precision of the representations. Hence, the input shapes per instance are (128×4) and (128×120), respectively, for the two branches of the fusion model.

In one embodiment, embedding features are extracted from the first fully-connected layer of the neural network model of foreground speech detector 201 instead of the last. In one embodiment, before concatenation, the extracted foreground representations are stacked every 30 seconds to match the output of the other branch. The 1D convolution is performed along the temporal dimension of the features in each branch. The number of trainable parameters is 0.8 million for the fusion model, which is lightweight for real-time deployment on edge devices.

In one embodiment, fusion engine 204 fuses the inertial data with audio data so as to consider not only verbal cues but also non-verbal gestures in conversations. Such non-verbal conversational gestures effectively supplement the information lost in downgraded audio.

In one embodiment, the principles of the present disclosure are implemented on a Google® Fossil Watch Gen 5. In one embodiment, the deployed application of the present disclosure on the Google® Fossil Watch Gen 5 is capable of inferring sound classes of conversation, other speech, and ambient sound at a granularity of 30 seconds. A cycle of inference is defined as the entire process of capturing audio, extracting features, and model inference. The application executes individual inference cycles independently when requested via buttons. Once running, the application first triggers the device's microphone 411 to continuously capture audio at 16 kHz for 30 seconds. The FFT features are then calculated with the Noise3 library, and the fusion network is called to generate the inference results.

In one embodiment, the application leverages the lowest sampling rate supported by smart wearable device 102 as the normal sampling rate to examine each second of incoming audio signals (e.g., Δt1). A high sampling rate is triggered only if the accumulated energy of the second (e.g., Δt2) exceeds a threshold of δ. After an inference cycle (Δt3), the application resumes capturing audio at the low sampling rate (Δt4). In one embodiment, the battery life is extended in this mode. In one embodiment, all processing is local on the device, and the captured audio is deleted after each inference cycle. In one embodiment, for over ten continuous cycles of inference on smart wearable device 102 (e.g., Fossil watch), the average latency for FFT calculation and model inference is 1,405 ms per instance.

In one embodiment, in order to extend the battery life of smart wearable device 102, an adaptive sampling strategy is implemented that seeks to reduce the number feature extraction and model inference processes since these processes utilize the most energy of the application without missing conversations. In this framework, the application first captures one second of audio at 4 kHz, the lowest sampling rate supported by an exemplary smart wearable device 102, and examines the accumulated energy of the signal. If the audio energy exceeds a threshold, the sampling rate increases to 16 kHz, and an inference cycle is triggered. Otherwise, the application checks the next incoming second of audio at the low sampling rate and continues in this manner. In one embodiment, the threshold is empirically determined, such as from a semi-naturalistic study based on the 10th percentile audio energy level in one-second segments with conversations. With this adaptive sampling framework, the battery life of smart wearable device 102 can be extended.

Furthermore, in one embodiment, the principles of the present disclosure may be applied to higher-order social interaction applications.

In one embodiment, once a conversation is detected, a model may be used to track the location and potential type of interaction (e.g., if the interaction happened during an office visit or at a party). For example, in one embodiment, training engine 202 may be configured to build and train a model to determine the type of interaction from a detected conversation using a sample data set that includes labeled conversations, such as outdoor, office visit, restaurant, and others. The class outdoor is for events outside of a building or in a vehicle. The class restaurant is associated with social events, such as at a restaurant. The class office visit includes the events of medical visits, conversations in an office, conversations in a grocery store, etc. Other conversational events are classified as others. In one embodiment, such a sample data set is compiled by an expert.

Furthermore, such a sample data set is referred to herein as the “training data,” which is used by a machine learning algorithm to make predictions or decisions as to the appropriate type of interaction from a detected conversation. The algorithm iteratively makes predictions of the type of interaction from a detected conversation until the predictions achieve the desired accuracy as determined by an expert. Examples of such learning algorithms include nearest neighbor, Naïve Bayes, decision trees, linear regression, support vector machines, and neural networks.

Another higher-order social interaction application may be substantive conversation detection. Features of conversation scenes may be used to describe different types of face-to-face conversations. In this setting, long conversation scenes typically indicate substantive conversations, which have been shown to be associated with greater well-being. In one embodiment, a model may be used to describe different types of face-to-face conversations, such as conversations of long duration (no less than one third of the input instance length) and conversations of short duration. For example, in one embodiment, training engine 202 may be configured to build and train a model to describe different types of face-to-face conversations using a sample data set that includes labeled conversations, such as conversations of long duration and conversations of short duration. In one embodiment, such a sample data set is compiled by an expert.

Furthermore, such a sample data set is referred to herein as the “training data,” which is used by a machine learning algorithm to make predictions or decisions as to the appropriate type of face-to-face conversations based on training data. The algorithm iteratively makes predictions of the type of face-to-face conversation until the predictions achieve the desired accuracy as determined by an expert. Examples of such learning algorithms include nearest neighbor, Naïve Bayes, decision trees, linear regression, support vector machines, and neural networks.

Another higher-order social interaction application may be substantive engagement recognition. During a social interaction, there is a strong correlation between speaker turn-takings and a speaker's engagement in the conversation. A model may be built and trained to quantify conversation engagement from detected conversations. For example, in one embodiment, training engine 202 may be configured to build and train a model to identify speaker engagement using a sample data set that includes labeled conversations, such as high engagement and low engagement. Detected conversations with only a single back and forth by the speakers or no switch of speaker turns are annotated as low engagement. Otherwise, conversations are annotated as high engagement. In one embodiment, such a sample data set is compiled by an expert.

Furthermore, such a sample data set is referred to herein as the “training data,” which is used by a machine learning algorithm to make predictions or decisions as to the type of social engagement from a detected conversation. The algorithm iteratively makes predictions of the type of social engagement from a detected conversation until the predictions achieve the desired accuracy as determined by an expert. Examples of such learning algorithms include nearest neighbor, Naïve Bayes, decision trees, linear regression, support vector machines, and neural networks.

As a result of the foregoing, embodiments of the present disclosure provide a means for automated detection of inter-person conversations between an individual wearing a smart wearable device (e.g., smartwatch) and nearby individuals based on a neural network-based feature fusion framework.

Furthermore, the present disclosure improves the technology or technical field involving techniques for detecting inter-person conversations. As discussed above, one of the fundamental components of social interactions is interpersonal communication (also referred to as “interpersonal conversations”), particularly face-to-face spoken communication (also referred to as “face-to-face conversations”). While face-to-face conversations have been traditionally studied and documented via self-reports, which poses a high-burden on individuals and introduces biases in the data, more recent methods have leveraged mobile devices to passively capture conversations in situ. However, while many proposed approaches are capable of detecting the occurrence of speech, they generally fall short when it comes to inferring moments when users are talking versus listening (e.g., to other people, watching television) and detecting and characterizing conversations (e.g., infer if the speech was a monologue or part of a face-to-face conversation). For example, attempts have been made to detect inter-person conversations, such as face-to-face conversation, without much success. For instance, one technique compares the mutual information or correlation between pairs of audio or voice streams captured from individual interacting subjects. To capture such signal streams, each subject holds an audio recording device, such as a smartphone, and signals collected by these devices are gathered to examine if a group of human subjects are within the same conversational session. In another technique, which is a non-acoustic approach, respirational signals are detected by attaching a customized sensor board to a user's body. Unfortunately, these approaches are deficient in detecting inter-person conversations. Furthermore, such approaches are difficult to implement requiring multiple devices or requiring a user to wear an uncomfortable device (e.g., customized sensor board).

Embodiments of the present disclosure improve such technology by capturing audio data on the smart wearable device. Such audio data may be from various sources, including sounds that only involve listening by an individual (e.g., lecture from college professor, television show, monologue) and sounds that involves an individual participating in face-to-face communication. A “face-to-face” communication (also referred to herein as “inter-person conversations”), as used herein, refers to an exchange of information between two or more people. Acoustic features are then extracted from the captured audio data. Such extracted acoustic features are a description of the captured audio data. An example of acoustic features includes spectrogram features. Neural network embedding features are then extracted from the extracted acoustic features using a first neural network model. “Neural network embedding features,” as used herein, are learned low-dimensional representations of discrete data continuous vectors. Furthermore, the extracted neural network embedding features are fused into a second neural network model (configured to detect inter-person conversations based on detecting speaker change point(s)) to perform user conversation inference. In this manner, inter-person conversations are more effectively detected using a smart wearable device (e.g., smartwatch). Furthermore, in this manner, there is an improvement in the technical field involving techniques for detecting inter-person conversations.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for detecting inter-person conversations using a smart wearable device, the method comprising:
capturing audio data on said smart wearable device;
extracting acoustic features from said captured audio data;
extracting neural network embedding features from said extracted acoustic features using a first neural network model; and
fusing said extracted neural network embedding features into a second neural network model to perform user conversation inference.

2. The method as recited in claim 1 further comprising:
detecting one or more speaker change points in said captured audio data corresponding to a boundary of speech turns for different speakers in a conversation using said second neural network model.

3. The method as recited in claim 2 further comprising:
detecting said one or more speaker change points within a range of 10-50 second intervals.

4. The method as recited in claim 2, wherein said second neural network model comprises two bi-directional long short-term memory layers and three fully-connected layers.

5. The method as recited in claim 1, wherein said acoustic features correspond to spectrogram features which are inputted to both said first and second neural network models.

6. The method as recited in claim 1, wherein said first neural network model comprises three two-dimensional convolutional layers.

7. The method as recited in claim 1, wherein said smart wearable device is a smartwatch.

8. The method as recited in claim 1, wherein said audio data is captured via an adaptive sampling strategy.

9. The method as recited in claim 1, wherein said audio data is temporarily retained in order to preserve privacy of an owner of said audio data.

10. The method as recited in claim 1 further comprising:
capturing inertial data on said smart wearable device;
extracting inertial features from said captured inertial data; and
extracting neural network embedding features from said extracted inertial features using a third neural network model.

11. The method as recited in claim 10 further comprising:
combining said extracted neural network embedding features from said extracted inertial features with said extracted neural network embedding features from said extracted acoustic features.

12. The method as recited in claim 11, wherein said extracted neural network embedding features from said extracted inertial features are combined with said extracted neural network embedding features from said extracted acoustic features using concatenation or cross-attention.

13. A computer program product for detecting inter-person conversations using a smart wearable device, the computer program product comprising one or more computer readable storage mediums having program code embodied therewith, the program code comprising programming instructions for:
capturing audio data on said smart wearable device;
extracting acoustic features from said captured audio data;
extracting neural network embedding features from said extracted acoustic features using a first neural network model; and
fusing said extracted neural network embedding features into a second neural network model to perform user conversation inference.

14. The computer program product as recited in claim 13, wherein the program code further comprises the programming instructions for:
detecting one or more speaker change points in said captured audio data corresponding to a boundary of speech turns for different speakers in a conversation using said second neural network model.

15. The computer program product as recited in claim 14, wherein the program code further comprises the programming instructions for:
detecting said one or more speaker change points within a range of 10-50 second intervals.

16. The computer program product as recited in claim 14, wherein said second neural network model comprises two bi-directional long short-term memory layers and three fully-connected layers.

17. The computer program product as recited in claim 13, wherein said acoustic features correspond to spectrogram features which are inputted to both said first and second neural network models.

18. The computer program product as recited in claim 13, wherein said first neural network model comprises three two-dimensional convolutional layers.

19. The computer program product as recited in claim 13, wherein said smart wearable device is a smartwatch.

20. The computer program product as recited in claim 13, wherein said audio data is captured via an adaptive sampling strategy.

21. The computer program product as recited in claim 13, wherein said audio data is temporarily retained in order to preserve privacy of an owner of said audio data.

22. The computer program product as recited in claim 13, wherein the program code further comprises the programming instructions for:
capturing inertial data on said smart wearable device;
extracting inertial features from said captured inertial data; and
extracting neural network embedding features from said extracted inertial features using a third neural network model.

23. The computer program product as recited in claim 22, wherein the program code further comprises the programming instructions for:
combining said extracted neural network embedding features from said extracted inertial features with said extracted neural network embedding features from said extracted acoustic features.

24. The computer program product as recited in claim 23, wherein said extracted neural network embedding features from said extracted inertial features are combined with said extracted neural network embedding features from said extracted acoustic features using concatenation or cross-attention.

25. A smart wearable device, comprising:
a memory for storing a computer program for detecting inter-person conversations; and
a processor connected to said memory, wherein said processor is configured to execute program instructions of the computer program comprising:
capturing audio data on said smart wearable device;
extracting acoustic features from said captured audio data;
extracting neural network embedding features from said extracted acoustic features using a first neural network model; and
fusing said extracted neural network embedding features into a second neural network model to perform user conversation inference.

26. The smart wearable device as recited in claim 25, wherein the program instructions of the computer program further comprise:
detecting one or more speaker change points in said captured audio data corresponding to a boundary of speech turns for different speakers in a conversation using said second neural network model.

27. The smart wearable device as recited in claim 26, wherein the program instructions of the computer program further comprise:
detecting said one or more speaker change points within a range of 10-50 second intervals.

28. The smart wearable device as recited in claim 26, wherein said second neural network model comprises two bi-directional long short-term memory layers and three fully-connected layers.

29. The smart wearable device as recited in claim 25, wherein said acoustic features correspond to spectrogram features which are inputted to both said first and second neural network models.

30. The smart wearable device as recited in claim 25, wherein said first neural network model comprises three two-dimensional convolutional layers.

31. The smart wearable device as recited in claim 25, wherein said smart wearable device is a smartwatch.

32. The smart wearable device as recited in claim 25, wherein said audio data is captured via an adaptive sampling strategy.

33. The smart wearable device as recited in claim 25, wherein said audio data is temporarily retained in order to preserve privacy of an owner of said audio data.

34. The smart wearable device as recited in claim 25, wherein the program instructions of the computer program further comprise:
capturing inertial data on said smart wearable device;
extracting inertial features from said captured inertial data; and
extracting neural network embedding features from said extracted inertial features using a third neural network model.

35. The smart wearable device as recited in claim 34, wherein the program instructions of the computer program further comprise:
combining said extracted neural network embedding features from said extracted inertial features with said extracted neural network embedding features from said extracted acoustic features.

36. The smart wearable device as recited in claim 35, wherein said extracted neural network embedding features from said extracted inertial features are combined with said extracted neural network embedding features from said extracted acoustic features using concatenation or cross-attention.
